(19) United States
(12) Patent Application Publication
(10) Pub. No.: US 2008/0129011 A1
(43) Pub. Date: Jun. 5, 2008

(54) Adjustable pin box

(76) Inventor: Philip M. Bouwkamp, Bristol, IN (US)

Correspondence Address: THE GATES CORPORATION, IP LAW DEPT. 10-A3, 1551 WEWATTA STREET, DENVER, CO, 80202, US

(21) Appl. No.: 11/633,854

(22) Filed: Dec. 5, 2006

(51) Int. Cl. B60D 1/46; B60D 1/44

(52) U.S. Cl. 280/490.1

(57) ABSTRACT

An adjustable pin box comprising a receiver tube, a hitch connector slideably engaged with the receiver tube, the hitch connector selectably positionable at a plurality of predetermined positions within the receiver tube, a fastener for securing the hitch connector at each predetermined position within the receiver tube, a beam connected to the receiver tube in a direction that extends substantially normal to the hitch connector, a receiver beam, the beam slideably engaged with the receiver beam, the beam selectably positionable at a plurality of predetermined positions within the receiver beam, a second fastener for securing the beam at each predetermined position within the receiver beam, and means for attaching the receiver beam to a frame.

### FIELD OF THE INVENTION

The invention relates to an adjustable pin box, and more particularly to an adjustable pin box having a king pin that is adjustable vertically and horizontally.

### BACKGROUND OF THE INVENTION

Trailers having goose neck tongues are equipped with hitch assemblies to connect the trailer to a towing vehicle such as a pickup truck. Upright support structures of the hitch assemblies are adjustable in length to accommodate different elevations of coupling structures of the towing vehicles. The vertical adjustment of the hitch assemblies has been achieved in various ways. Telescopic members that are pinned together are known.

Representative of the art is U.S. Pat. No. 7,121,574 (2006) to Bouwkamp which discloses a pin box for connecting a trailer to a tow vehicle includes a hollow receiver tube attached to a pair of support beams positioned on opposite sides of the receiver tube. A forward mounting bracket for attaching the pin box to a frame of the trailer is disposed between the two support beams. The mounting bracket is fixedly attached to both support beams. A second mounting bracket is attached to the ends of the support beams opposite the receiver tube. The pin box also includes a hitch connector that is slideably engageable with the receiver tube. The hitch connector may be positioned within the receiver tube at a plurality of discrete predetermined locations. An attaching means is provided for securing the hitch connector to the receiver tube at each of the predetermined locations. The hitch connector may be configured to include a king pin connector or a gooseneck connector. Differently configured hitch connectors may be interchangeably connected to the receiver tube.

What is needed is an adjustable pin box having a king pin that is adjustable vertically and horizontally. The present invention meets this need.

### SUMMARY OF THE INVENTION

The primary aspect of the invention is to provide an adjustable pin box having a king pin that is adjustable vertically and horizontally.

Other aspects of the invention will be pointed out or made obvious by the following description of the invention and the accompanying drawings.

The invention comprises an adjustable pin box comprising a receiver tube, a hitch connector slideably engaged with the receiver tube, the hitch connector selectably positionable at a plurality of predetermined positions within the receiver tube, a fastener for securing the hitch connector at each predetermined position within the receiver tube, a beam connected to the receiver tube in a direction that extends substantially normal to the hitch connector, a receiver beam, the beam slideably engaged with the receiver beam, the beam selectably positionable at a plurality of predetermined positions within the receiver beam, a second fastener for securing the beam at each predetermined position within the receiver beam, and means for attaching the receiver beam to a frame.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the adjustable pin box.

FIG. 2 is a side elevation view of the adjustable pin box.

FIG. 3 is a top plan view of the adjustable pin box.

FIG. 4 is a side elevation of a trailer and tow vehicle employing the adjustable pin box.

### DETAILED DESCRIPTION OF THE PREFERRED EMBODIMENTS

The instant invention simultaneously provides vertical and horizontal adjustability for a pin box having a king pin that is used with fifth wheel hitches.

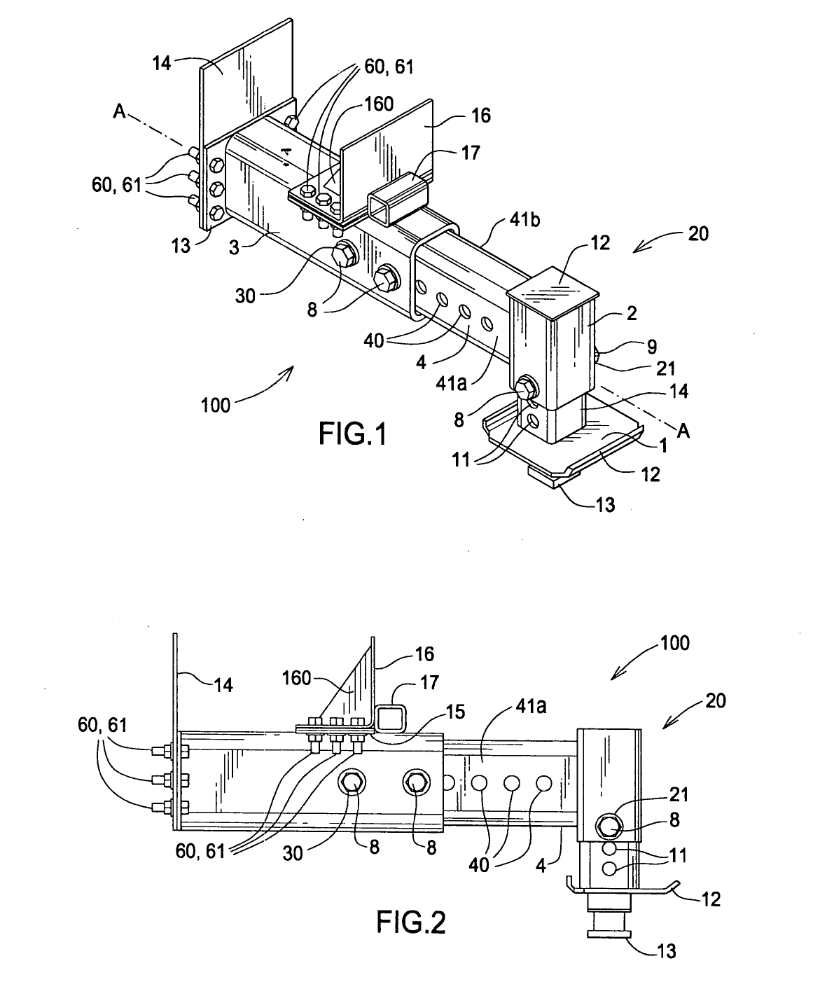

FIG. 1 is a perspective view of the adjustable pin box. The assembly of the present invention comprises a pin box 20. Pin box 20 comprises a receiver tube 2 for receiving and attaching the hitch connector 1 to pin box 20. Hitch connector 1 comprises a beam 14, skid plate 12 and king pin 13. Skid plate 12 is disposed normally to the king pin 13 in order to facilitate engagement of the king pin with a fifth wheel hitch.

Receiver tube 2 is preferably oriented substantially vertical when pin box 20 is attached to frame 240 of trailer 220. Of course, other angular orientations may be used, for example having a slight incline backward from the bottom of the receiver tube to the top of the receiver tube. Receiver tube 2 may comprise a box section of round section. The preferred embodiment comprises a box section.

A cooperating pair of holes 21 are disposed on opposing sides of receiver tube 2. Cooperating pairs of holes 11 are disposed on opposing sides of beam 14 of hitch connector 1, thereby creating a plurality of selectable positions for the beam 14 within receiver tube 2. To secure beam 14 within receiver tube 2 a bolt 8 is engaged through pairs of holes 21 and holes 11. Nut 9 is used to secure bolt 8 into holes 21 and holes 11.

King pin 13 projects from one end of beam 14. Skid plate 12 facilitates proper alignment of the king pin 13 during coupling to a fifth wheel hitch, see FIG. 4.

Beam 4 is connected by welding to a side of receiver tube 2. Beam 4 comprises holes 40 disposed along parallel sides 41a, 41b of beam 4. The holes are arranged in cooperating pairs on opposing sides of beam 4 in order to cooperatively receive bolts 8.

Receiver beam 3 receives beam 4. Receiver beam 3 has a shape and size sufficient to cooperatively allow beam 4 to be slipped into receiver beam 3. In the preferred embodiment receiver beam has a box shape to receive beam 4. Cooperating pairs of holes 30 are disposed on opposing sides of receiver beam 3, thereby creating a plurality of selectable positions for beam 4. Holes 30 are spaced apart from each other in a manner that is substantially identical to the spacing of holes 40.

Bolts 8 are engaged through pairs of holes 30 and holes 40. Nuts 9 are used to secure bolts 8 into holes 30 and holes 40.

Mounting plates 14 and 16 are secured to plates 13 and 15 respectively on receiver beam 3 by use of bolts 60 and nuts 61. Plates 13 and 15 are welded to receiver beam 3. Mounting plates 14 and 16 are then welded or otherwise secured to a trailer frame. Since receiver beam 3 is bolted to the mounting plates 14 and 16, receiver beam 3 can be easily removed from a trailer if necessary.

Member 17 provides reinforcement to prevent excessive movement of the hitch in an axis parallel to the major axis A-A of receiver beam 3 that may be caused by bending or folding of mounting plates 14 or 16.

The combination of vertical and horizontal adjustability afforded by the inventive adjustable pin box allows a user to advantageously adjust the king pin position for engaging a fifth wheel hitch regardless of the position of the fifth wheel hitch on the tow vehicle.

FIG. 2 is a side elevation view of the adjustable pin box. Gusset 160 reinforces mounting plate 16. The number of pairs of holes 40 are only limited by the length of beam 4, thereby creating a plurality of positions for beam 4. Member 17 comprises a box shape in the noted embodiment. Mounting plates 14 and 16 may be welded or bolted to the trailer frame.

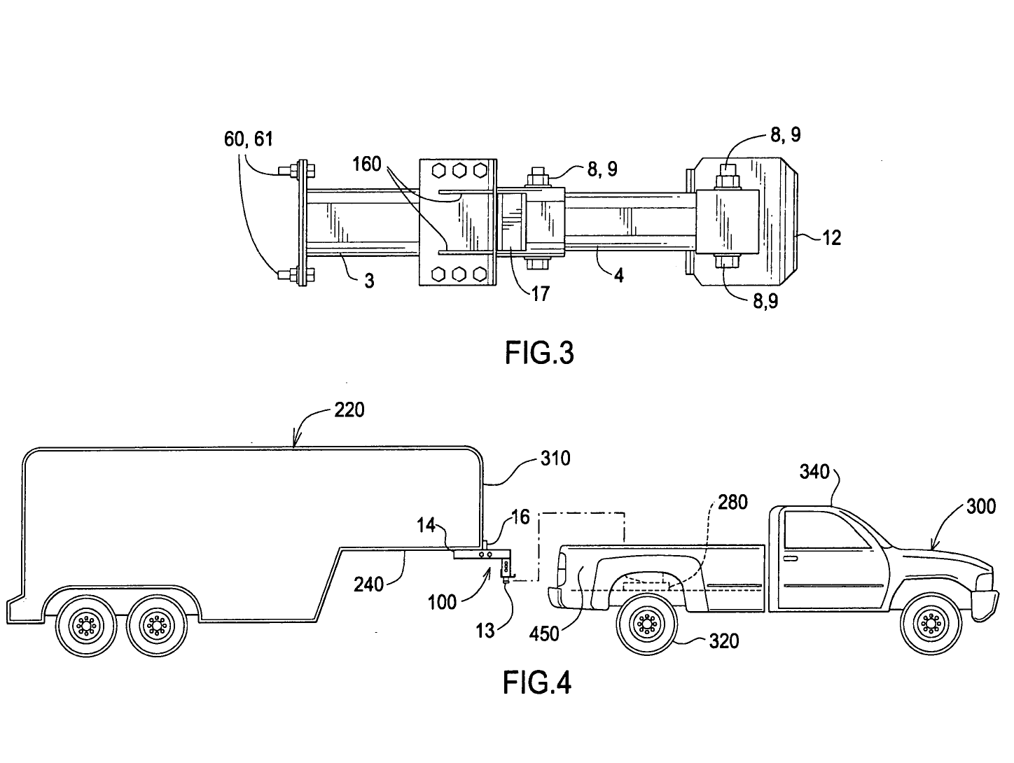

FIG. 3 is a top plan view of the adjustable pin box. Beam 4 adjustably extends from receiver beam 3 so that it can be adjusted to a position compatible with the hitch location.

FIG. 4 is a side elevation of a trailer and tow vehicle employing the adjustable pin box. Adjustable pin box 100 is connected to a trailer frame 240 and 310 by welding mounting plates 14 and 16 thereto.

Trailer 220 is towed by a tow vehicle 300. Tow vehicle 300 may comprise a pick-up truck, or tractor, or any other suitable vehicle. Fifth wheel hitch 280 is installed in the bed 450 of tow vehicle 200. Tow vehicle 300 comprises a cab 340 for a driver.

The spatial position of fifth wheel hitch 280 is a function of its position in the bed 450 as well as the ride height of the vehicle as determined, in part, by the suspension and wheel 320 size. The fifth wheel hitch 280 is generally positioned over or slightly ahead of drive wheels 320 for reasons of safety.

The position of king pin 13 is adjusted as described herein to allow proper trailer height and clearance when the trailer is under tow behind the tow vehicle.

Although a form of the invention has been described herein, it will be obvious to those skilled in the art that variations may be made in the construction and relation of parts without departing from the spirit and scope of the invention described herein.

We claim:

1. An adjustable pin box comprising:
a receiver tube;
a hitch connector slideably engaged with the receiver tube, the hitch connector selectably positionable at a plurality of predetermined positions within the receiver tube;
a fastener for securing the hitch connector at each predetermined position within the receiver tube;
a beam connected normally to the receiver tube;
a receiver beam;
the beam slideably engaged with the receiver beam, the beam selectably positionable at a plurality of predetermined positions within the receiver beam;
a second fastener for securing the beam at each predetermined position within the receiver beam; and
means for attaching the receiver beam to a frame.

2. The adjustable pin box as in claim 1, wherein the hitch connector further comprises a king pin.

3. The adjustable pin box as in claim 1, wherein the fastener comprises a bolt.

4. The adjustable pin box as in claim 1, wherein the second fastener comprises a bolt.

5. The adjustable pin box as in claim 2, wherein the hitch connector further comprises a skid plate disposed normally to the king pin.
